(19) United States
(12) Patent Application Publication
(10) Pub. No.: US 2013/0322203 A1
(43) Pub. Date: Dec. 5, 2013

(54) Starch Glue Kitchen

(71) Applicant: Chen Hui Chen, Kaohsiung City (TW)

(72) Inventor: Chen Hui Chen, Kaohsiung City (TW)

(73) Assignee: CHUEN HUAH CHEMICAL CO., LTD., Kaohsiung City (TW)

(21) Appl. No.: 13/487,244

(22) Filed: Jun. 3, 2012

(51) Int. Cl. B01F 15/04

(52) U.S. Cl. 366/152.5

(57) ABSTRACT

A starch glue kitchen includes a plurality of raw material barrels, a mixing barrel, a pump, a viscosity detector, and a computer. The raw material barrels include a starch barrel, a water barrel, a thickener barrel, a crosslink agent barrel, and a chemical additive barrel. The mixing barrel is used to uniformly mix the raw materials put therein. The bottom of the mixing barrel is provided with a delivery conduit. The other end of the delivery conduit extends into the mixing barrel. The pump is provided on the delivery conduit of the mixing barrel. The viscosity detector is provided on the delivery conduit between the bottom of the mixing barrel and the pump. The computer is configured to receive signals inputted from the viscosity detector and controllably adjust the amount of raw materials outputted from the respective raw material barrels and a mixing period of the mixing barrel.

### BACKGROUND OF THE INVENTION

1. Field of the Invention

The invention relates to a starch glue kitchen for producing glue by using starch as a raw material, and in particular to a starch glue kitchen which is capable of automatically detecting and adjusting the viscosity of starch glue to thereby increase the quality stability and production efficiency of the starch glue.

2. Description of Prior Art

Starch glue is widely used in paper-making industry. For example, the starch glue can be used as glue for producing corrugated paperboards.

The starch glue is glue made by using starch (e.g. flour, starch, oxidized starch, chemical starch etc.) as a raw material. During the production, a suitable amount of water is added into a predetermined amount of starch and then mixed with each other uniformly. Then, a suitable mount of thicker (such as hot water, soda or vapors) is added into the above-formed mixture and further mixed completely, so that the starch can be made into a semi-viscous paste. Next, a suitable amount of crosslink agent (such as borax or boric acid) and chemical additive (such as resin) are added into the semi-viscous paste, thereby increasing the viscosity and quality stability of the starch glue. In this way, the production of starch glue is achieved.

During the production of starch glue, the well control over the viscosity of starch glue is a critical factor in determining the quality of the starch glue. Each step of the production process will affect the viscosity of starch glue. Thus, the viscosity of starch glue should be often detected during the production thereof.

However, according to the existing starch glue kitchen, the measurement of the viscosity of starch glue is performed manually. More specifically, an operator uses a measuring gauge to measure the viscosity of starch glue based on his/her visual inspections and experience. Thus, such a manual measurement of the viscosity of starch glue takes a lot of time and labors. Unfortunately, the quality of the starch glue made in this way is uneven because of personal errors. Especially, most of the starch used in producing the starch glue is natural starch extracted from crops such as corns or potatoes. As a result, the properties of the natural starch may be affected by their breeds, places of origin, seasons and etc., so that even the same batch of natural starch may have different qualities. Therefore, manually measuring the viscosity of starch glue will make the quality of the starch glue more unstable, which is a big problem for the manufactures in this field.

### SUMMARY OF THE INVENTION

The primary objective of the invention is to provide a starch glue kitchen, which is capable of automatically detecting and adjusting the viscosity of starch glue to thereby increase the quality stability and production efficiency of starch glue.

In order to achieve the above objective, the invention provides a starch glue kitchen, which comprises a plurality of raw material barrels, at least one mixing barrel, a pump, a viscosity detector, and a computer. The raw material barrels at least comprise a starch barrel for storing starch (such as flour, starch, oxidized starch, chemical starch or the like), a water barrel for storing water, a thickener barrel for storing a thickener (such as soda, vapors, or hot water), a crosslink agent barrel for storing a crosslink agent (such as borax or boric acid), and a chemical additive barrel for storing a chemical additive (such as resin).

The mixing barrel is used to uniformly mix the raw materials put therein. The bottom of the mixing barrel is provided with a delivery conduit. The other end of the delivery conduit extends into the mixing barrel from the upside of the mixing barrel.

The pump is provided on the delivery conduit of the mixing barrel.

The viscosity detector is provided on the delivery conduit between the bottom of the mixing barrel and the pump.

The computer is configured to receive signals inputted from the viscosity detector and controllably adjust the amount of raw materials outputted from the respective raw material barrels and a mixing period of the mixing barrel.

With the above structure, a starch glue kitchen can be obtained, which is capable of automatically detecting and adjusting the viscosity of starch glue to thereby increase the quality stability and production efficiency of starch glue.

### BRIEF DESCRIPTION OF THE DRAWINGS

FIG. 1 is a schematic view showing the structure of an embodiment of the invention; and

FIG. 2 is a schematic view showing the process for producing starch glue by using the structure of the embodiment of the invention.

### DETAILED DESCRIPTION OF THE INVENTION

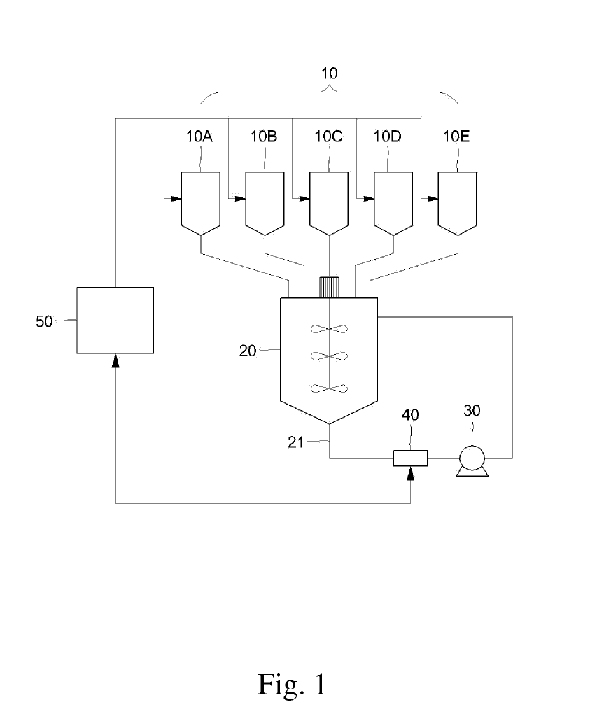

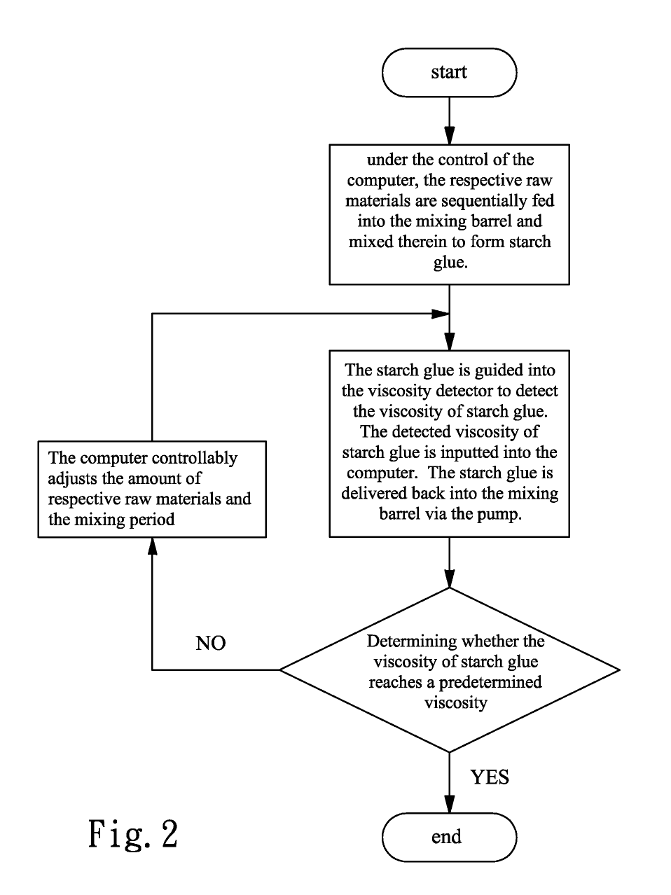

The technical measures and method of the invention in order to achieve the above objectives will be described in more detail with reference to preferred embodiment thereof shown in FIG. 1 and a process shown in FIG. 2.

As shown in FIG. 1, the embodiment of the invention provides a starch glue kitchen, which comprises a plurality of raw material barrels 10, at least one mixing barrel 20, a pump 30, a viscosity detector 40, and a computer 50.

The raw material barrels 10 shown in FIG. 1 are used to accommodate raw materials necessary for producing the starch glue. The raw material barrels 10 at least comprise: a water barrel 10A for storing water, a starch barrel 10B for storing starch (such as flour, starch, oxidized starch, chemical starch or the like), a thickener barrel 10C for storing a thickener (such as soda, vapors, or hot water), a crosslink agent barrel 10D for storing a crosslink agent (such as borax or boric acid), and a chemical additive barrel 10E for storing a chemical additive (such as resin).

The mixing barrel 20 shown in FIG. 1 is used to uniformly mix the raw materials put therein. The bottom of the mixing barrel 20 is provided with a delivery conduit 21. The other end of the delivery conduit 21 extends into the mixing barrel 20 from the upside of the mixing barrel 20.

The pump 30 shown in FIG. 1 is provided on the delivery conduit 21 of the mixing barrel 20.

The viscosity detector 40 shown in FIG. 1 is provided on the delivery conduit 21 between the bottom of the mixing barrel 20 and the pump 30.

The computer 50 shown in FIG. 1 is configured to receive signals inputted from the viscosity detector 40 and controllably adjust the amount of raw materials outputted from the respective raw material barrels 10 and a mixing period of the mixing barrel 20.

Please refer to FIG. 2 showing the process for producing starch glue by using the above structure of the embodiment of the invention. In the beginning, under the control of the computer 50, the water in the water barrel 10A, the starch in the starch barrel 10B, the thickener (such as soda, vapors or hot water) in the thickener barrel 10C, the crosslink agent (such as borax, boric acid) in the crosslink agent barrel 10D, and the chemical additive (such as resin) in the chemical additive barrel 10E are sequentially fed into the mixing barrel 20, and all of them are mixed uniformly in the mixing barrel 20 to form starch glue. During the mixing step, the starch glue is continuously delivered from the delivery conduit 21 on the bottom of the mixing barrel 20 to the viscosity detector 40. In this way, the viscosity detector 40 continuously detects the viscosity of starch glue, and inputs the detected viscosity into the computer 50. The starch glue is delivered back into the mixing barrel 20 via the pump 30.

When the viscosity detector 40 detects the viscosity of starch glue, the viscosity of starch glue detected by the viscosity detector 40 is inputted into the computer 50. Then, the computer 50 controllably adjusts the amount of respective raw materials and the mixing period until the viscosity of starch glue detected by the viscosity detector 40 reaches the predetermined viscosity. In this way, the starch glue of a desired viscosity can be obtained.

By the above process, during the production of starch glue, the viscosity detector 40 continuously detects the viscosity of starch glue. Thus, the operator can recognize the viscosity of starch glue immediately, so that the operator can adjust the amount of the respective raw materials and the mixing period accordingly. In this way, the quality stability and the production efficiency of the starch glue can be increased.

According to the above description and figures, the variation in viscosity of starch glue can be detected immediately during its production, so that the operator can adjust the amount of respective raw materials and the mixing period accordingly. In this way, the quality stability and the production efficiency of starch glue can be increased. Therefore, the invention really demonstrates novelty and inventive steps, which conforms to the requirements for an invention patent.

Although the invention has been described with reference to the foregoing preferred embodiment, it will be understood that the invention is not limited to the details thereof. Various equivalent variations and modifications can still occur to those skilled in this art in view of the teachings of the embodiment of the invention. Thus, all such variations and equivalent modifications are also embraced within the scope of the invention as defined in the appended claims.

What is claimed is:

1. A starch glue kitchen, comprising a plurality of raw material barrels, a mixing barrel, a pump, a viscosity detector, and a computer, wherein
the plurality of raw material barrels at least comprise a starch barrel for storing starch, a water barrel for storing water, a thickener barrel for storing a thickener, a crosslink agent barrel for storing a crosslink agent, and a chemical additive barrel for storing a chemical additive;
the mixing barrel is used to uniformly mix the raw materials put therein, the bottom of the mixing barrel is provided with a delivery conduit, the other end of the delivery conduit extends into the mixing barrel from the upside of the mixing barrel;
the pump is provided on the delivery conduit of the mixing barrel;
the viscosity detector is provided on the delivery conduit between the bottom of the mixing barrel and the pump; and
the computer is configured to receive signals inputted from the viscosity detector and controllably adjust the amount of raw materials outputted from the respective raw material barrels and a mixing period of the mixing barrel.
